(19) United States
(12) Patent Application Publication
(10) Pub. No.: US 2006/0023446 A1
(43) Pub. Date: Feb. 2, 2006

(54) Solar lighting system for a flag

(76) Inventor: Eric Racoosin, Laguna Niguel, CA (US)

Correspondence Address: LAW OFFICES OF ERIC KARICH, 2807 ST. MARK DR., MANSFIELD, TX, 76063, US

(21) Appl. No.: 10/909,524

(22) Filed: Aug. 2, 2004

(51) Int. Cl. B60Q 1/26

(52) U.S. Cl. 362/227

(57) ABSTRACT

A lighting system for a flag is disclosed, including a lighting element, a housing adapted to receive the lighting element, a mounting element adapted to mount the housing on the flag, and a power source for supplying electrical power to the lighting element. The lighting element produces light, and the housing substantially transmits the light produced by the lighting element. The power source, preferably a combination solar panel and battery, is adapted for connection to the lighting element. Also described is a flag including a piece of cloth having a lighting element disposed therein, wherein the lighting element produces light and includes multiple spaced apart lighting strips arranged substantially in parallel.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to flags, and more particularly to flags with an integral solar lighting system.

2. Description of Related Art

A flag is piece of cloth, usually rectangular, of distinctive color and design, and used as a symbol, standard, signal, or emblem. Throughout history organizational flags have been used to stimulate pride and devotion. At public functions and gatherings, U.S. citizens are often called upon to recite the Pledge of Allegiance, a promise to be loyal to the U.S. flag and to the nation it represents.

The etiquette for displaying the U.S. Flag is established by law in Chapter 1 of Title 4 of the U.S. Code. Section 6(a) states:
“It is the universal custom to display the flag only from sunrise to sunset on buildings and on stationary flagstaffs in the open. However, when a patriotic effect is desired, the flag may be displayed 24 hours a day if properly illuminated during the hours of darkness.”

It would thus be beneficial to have a relatively simple and inexpensive system for lighting a flag, such as the U.S. flag, during hours of darkness.

### SUMMARY OF THE INVENTION

A lighting system for a flag is disclosed, including a lighting element, a housing adapted to receive the lighting element, a mounting element adapted to mount the housing on the flag, and a power source for supplying electrical power to the lighting element. The lighting element produces light, and the housing substantially transmits the light produced by the lighting element. The power source, preferably a combination solar panel and battery, is adapted for connection to the lighting element. Also described is a flag including a piece of cloth having a lighting element disposed therein, wherein the lighting element produces light and includes multiple spaced apart lighting strips arranged substantially in parallel.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a front elevation view of a flag having components of one embodiment of a lighting system mounted along an outer edge, wherein the lighting system includes a housing containing a lighting element;

FIG. 2 is a sectional view of a portion of the housing and the lighting element as indicated in FIG. 1;

FIG. 3 is a diagram of one embodiment of a power source of the lighting system of FIG. 1; and

FIG. 4 is a sectional view of another flag including a piece of cloth having a lighting element disposed therein.

### DETAILED DESCRIPTION OF THE INVENTION

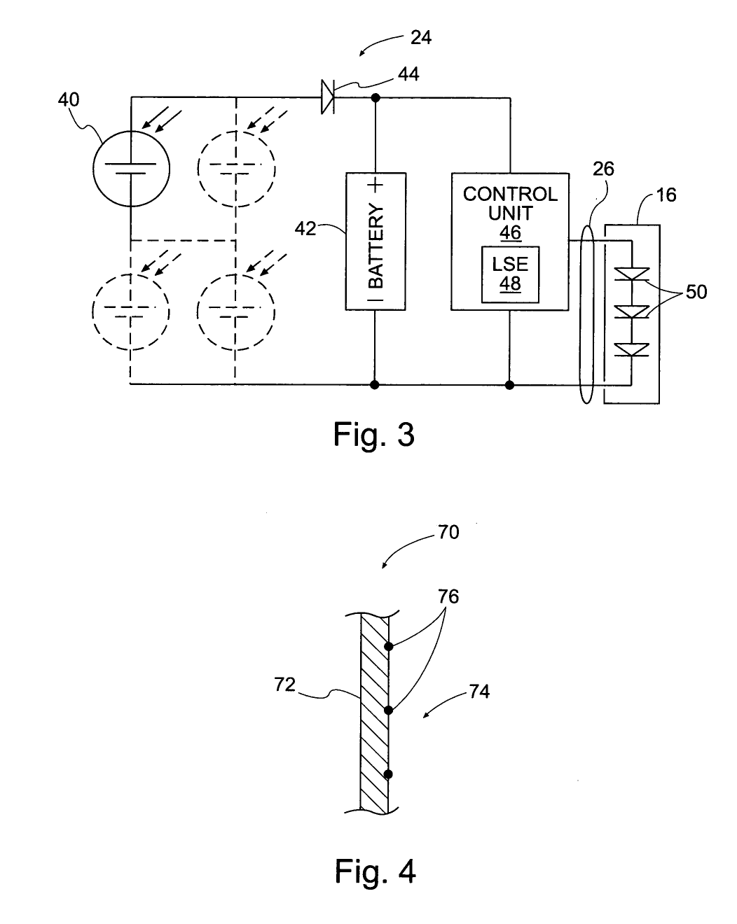

The above-described drawing figures illustrate the invention, a flag 10 that includes a flag body 10A and a lighting element 16 configured to produce light. The lighting element 16 is directly incorporated into the flag body 10A with a mounting element, described in greater detail below. The lighting element 16 is powered by a power source 24 that is adapted to be operably connected to the lighting element 16. The power source 24, described in greater detail below, preferably includes solar panels 40 (shown in FIG. 3).

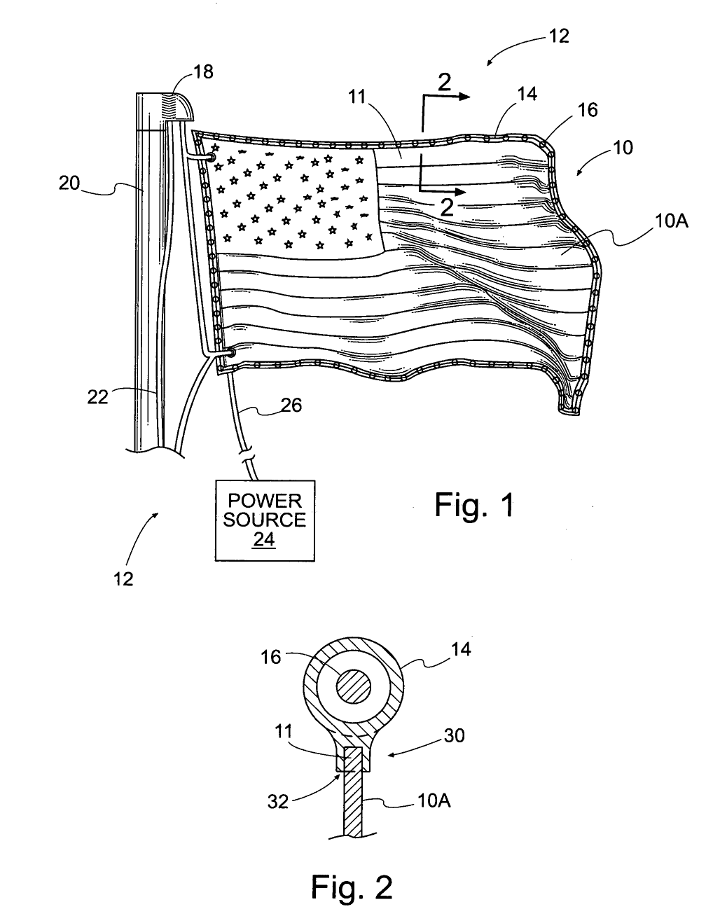

FIG. 1 is a front elevation view of one embodiment of a flag 10 having components of one embodiment of a lighting system 12 mounted along an outer edge 11. The lighting system 12 is designed to illuminate the flag 10 during hours of darkness, and is and is relatively simple and inexpensive. In this embodiment, the mounting element includes a housing 14. The housing 14 of the lighting system 12 functions to contain the lighting element 16, and is mounted along the outer edge 11 of the flag 10. The flag 10 is positioned near a top of a flag pole 20 adjacent a truck assembly 18, and is attached to a halyard 22 for raising and lowering the flag 10 on the flag pole 20.

In addition to the housing 14 and the lighting element 16, the lighting system 12 also includes a power source 24. In the embodiment of FIG. 1, the power source 24 is connected to the lighting element 16 via an electrical cord 26. In general, the lighting element 16 is an electrical light source that produces light when supplied electrical power, and the power source 24 is provided for supplying electrical power to the lighting element 16.

In the embodiment of FIG. 1, the power source 24 supplies electrical power to the lighting element 16 via the electrical cord 26. The power source 24 is adapted for connecting to one end of the electrical cord 26, and the lighting element 16 is adapted for connecting to the other end of the electrical cord 26. The power source 24 may be positioned, for example, near a base of the flag pole 20.

The housing 14 is adapted to receive the lighting element 16, and substantially transmits the light produced by the lighting element 16. In a preferred embodiment, the lighting element 16 produces visible light, and the housing 14 substantially transmits the light produced by the lighting element 16.

The lighting element 16 may be or include, for example, a string of light-emitting diodes (LEDs). Such a string of LEDs may include multiple LEDs connected one after another in succession. Alternately, the lighting element 16 may be or include an electroluminescent strip, fiber optics, or any other form of lighting known to one skilled in the art.

FIG. 2 is a sectional view of a portion of the housing 14 and the lighting element 16 as indicated in FIG. 1. As illustrated in FIG. 2, the housing 14 substantially surrounds the lighting element 16 and protects the lighting element 16 from physical damage as well as environmental hazards such as ultraviolet radiation from sunlight and the various forms of precipitation. The housing 14 may include a mounting component 30 for mounting the housing 14 on the outer edge 11 of the flag 10. The mounting component 30 may include a gripping structure having a groove 32 to receive the outer edge 11 of the flag 10, wherein the gripping structure 30 is integral part of the housing 14. It is noted that in other embodiments, the mounting component 30 used to mount the housing 14 to the flag 10 may be a separate component, and may include any number of structures that function to attach the housing 14 to the flag 10, including but not limited to sewing, stapling, welding, bonding, sealing, or otherwise attaching the housing 14 to the flag 10.

FIG. 3 is a diagram of one embodiment of the power source 24 of FIG. 1. In the embodiment of FIG. 3, the power source 24 includes at least one photovoltaic cell (i.e., solar cell) 40. As indicated in FIG. 3, the power source 24 may include other photovoltaic cells connected in series and/or in parallel with the photovoltaic cell 40. The photovoltaic cell 40 is preferably connected to a battery 42 via a diode 44, which prevents the battery 42 from discharging through the photovoltaic cell 40 when the photovoltaic cell 40 is not exposed to light.

The power source 24 includes a control unit 46 coupled between the battery 42 and the lighting element 16. In general, the control unit 46 provides electrical power from the battery 42 to the lighting element 16 when an ambient light level is below a predetermined threshold level (i.e., during hours of darkness). The control unit 46 includes a light sensitive element (LSE) 48 such as a photocell, and uses the LSE 48 to determine when the ambient light level is below the predetermined threshold level.

In general, the control unit 46 generally produces electrical voltage and current required by the lighting element 16 for proper starting and desired operation. For example, as shown in FIG. 3, the lighting element 16 may include multiple LEDs 50 connected in series. In this situation, the control unit 46 may limit the electrical current and/or voltage provided to the LEDs 50 such that the LEDs 50 do not draw excessive electrical power and fail prematurely.

As described above, the lighting element 16 may also be or include an electroluminescent strip. In general, electroluminescent devices require an alternating current (AC) voltages having suitable magnitudes and frequencies to stimulate phosphor coatings sandwiched between pairs of electrodes. In this situation, the control unit 46 may be or include an inverter circuit that generates an AC voltage having a suitable magnitude and frequency, and may provide the AC voltage to the electroluminescent strip.

FIG. 4 is a sectional view of another flag 70 including a piece of cloth 72 having a lighting element 74 disposed therein. In this embodiment, the mounting element is provided by the piece of cloth 72 itself, as the lighting element 74 is woven or otherwise integrated into the flag 70. The lighting element 74 is configured to produce light, and includes multiple spaced apart lighting strips 76 that are preferably arranged substantially in parallel. The lighting strips 76 may be, for example, woven into the piece of cloth 72 (e.g., when the flag 70 is manufactured). The lighting strips may be or include, for example, electroluminescent strips.

While two examples of the mounting element are described in detail, the term mounting element is hereby expressly defined to include any other mounting methods, devices, or elements that function to link the lighting element (16 and 74) with the flag (10 and 70), including but not limited to sewing, stapling, welding, bonding, sealing, or otherwise attaching the lighting element to the flag.

In general, the lighting element 74 is adapted for connection to a power source. For example, referring to FIGS. 1 and 4, the lighting element 74 of FIG. 4 may be adapted for connecting to one end of an electrical cord such as the electrical cord 26 of FIG. 1. The power source may be similar to the power source 24 of FIG. 1, adapted for connecting to the other end of the electrical cord 26 of FIG. 1.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A lighting system for a flag, the lighting system comprising:
a lighting element configured to produce light;
a mounting element adapted to mount the lighting element on the flag, the mounting element including a housing adapted to receive the lighting element, wherein the housing substantially transmits the light produced by the lighting element; and
a power source for supplying electrical power to the lighting element, wherein the power source is adapted to be operably connected to the lighting element.

2. The lighting system as recited in claim 1, wherein the lighting element comprises a string of light-emitting diodes.

3. The lighting system as recited in claim 2, wherein the string of light-emitting diodes comprises a plurality of light-emitting diodes connected one after another in succession.

4. The lighting system as recited in claim 1, wherein the lighting element comprises an electroluminescent strip.

5. The lighting system as recited in claim 1, wherein the housing substantially surrounds the lighting element and protects the lighting element.

6. The lighting system as recited in claim 1, wherein the housing includes a mounting component that is adapted to mount the housing to an outer edge of the flag.

7. The lighting system as recited in claim 1, wherein the mounting element is an integral part of the housing.

8. The lighting system as recited in claim 1, wherein the power source comprises a battery.

9. The lighting system as recited in claim 1, wherein the power source comprises at least one photovoltaic cell.

10. The lighting system as recited in claim 1, wherein the power source comprises a control unit configured to provide electrical power to the lighting element

11. The lighting system as recited in claim 1, wherein the control unit comprises a light sensitive element.

12. A flag comprising:
a piece of cloth having a lighting element disposed therein, wherein the lighting element is configured to produce light and comprises a plurality of spaced apart lighting strips.

13. The flag as recited in claim 12, wherein the lighting strips are woven into the piece of cloth.

14. The flag as recited in claim 12, wherein the lighting strips comprise electroluminescent strips.

15. The flag as recited in claim 12, wherein the lighting element is adapted for connection to a power source.

16. The flag as recited in claim 12, wherein the plurality of spaced apart lighting strips are arranged substantially in parallel

17. A flag comprising:
a flag body;
a lighting element configured to produce light;
a mounting element adapted to mount the lighting element on the flag; and
a power source for supplying electrical power to the lighting element, wherein the power source is adapted to be operably connected to the lighting element.

18. The flag as recited in claim 17, wherein the lighting element comprises a string of light-emitting diodes.

19. The flag as recited in claim 18, wherein the string of light-emitting diodes comprises a plurality of light-emitting diodes connected one after another in succession.

20. The flag as recited in claim 17, wherein the lighting element comprises an electroluminescent strip.
